(19) United States
(12) Patent Application Publication
(10) Pub. No.: US 2025/0144721 A1
(43) Pub. Date: May 8, 2025

(54) TOOL CHUCK, METHOD OF USING A TOOL CHUCK AND TOOL CLAMPING SYSTEM

(71) Applicant: Franz Haimer Maschinenbau KG, Hollenbach-Igenhausen (DE)

(72) Inventor: Franz Haimer, Hollenbach-Igenhausen (DE)

(21) Appl. No.: 18/935,867

(22) Filed: Nov. 4, 2024

(30) Foreign Application Priority Data
Nov. 2, 2023 (DE) 10 2023 130 360.0

(51) Int. Cl. B23B 31/20; B23C 5/26

(52) U.S. Cl. CPC B23B 31/20; B23C 5/26

(57) ABSTRACT

A tool chuck for clamping tools incudes a sleeve section with an open free end adjoining a tool chuck main body towards the free end. The sleeve section forms a tool receptacle for fixedly receiving the tool shank in a friction-fitting manner with an interference fit. The sleeve section is formed of inner and outer sleeves. The outer sleeve, in an operationally ready state, receives the inner sleeve and is joined thereto without clearance. There is an expansion gap between the tool chuck main body, the inner sleeve and the outer sleeve, or at least one first intermediate sleeve is disposed between the inner and outer sleeves, or a functional face of at least one of the structural parts joined to one another at the sleeve section is thermochemically heat-treated and/or coated. A method of using a tool chuck and a chuck system are also provided.

### CROSS-REFERENCE TO RELATED APPLICATION

This application claims the priority, under 35 U.S.C. § 119, of German Patent Application DE 10 2023 130 360.0, filed Nov. 2, 2023; the prior application is herewith incorporated by reference in its entirety.

### FIELD AND BACKGROUND OF THE INVENTION

The invention relates to a tool chuck for clamping tools having a tool shank, the tool chuck includes a sleeve section which is open at the free end thereof, adjoins a tool chuck main body towards the free end, is made of preferably electrically conducting material and forms a tool receptacle for fixedly receiving the tool shank in a friction-fitting manner in an interference fit, in particular by shrinkage, wherein the sleeve section—preferably in any case over the entire axial length of the tool receptacle—is formed of an inner sleeve and an outer sleeve which in the operationally ready state receives the inner sleeve, is joined thereto without any clearance and preferably likewise is formed of an electrically conducting material. The invention also relates to a method of using the tool chuck for high-speed subtractive machining, in particular for high-speed milling (HSC) or CAD/CAM-optimized trochoidal milling, both preferably at a cutting speed of more than 800 m/min, preferably more than 1100 m/min, or high performance milling (HPC). Finally, the invention relates to a chuck system including at least one tool chuck according to the invention, and a shank tool which is adapted thereto in terms of its nominal shank diameter.

Chucks in the form of shrink-fit chucks have proven very successful in practice because they can apply very high holding forces with little complexity. Moreover, they offer the possibility of holding the clamped tool with a high flexural stiffness so that the tool is precisely guided and generates a highly accurate geometry on the workpiece during the subtractive machining procedure. At the same time, however, they often clamp the tool shank very rigidly or firmly, on account of which the set of issues relating to vibrations gains importance.

The quality of clamping of a shank tool is of great importance with a view to the machining quality to be achieved by the tool and frequently also with a view to the service life of the tool.

This applies all the more to the high-speed subtractive machining of metals, in particular at a cutting rate of more than 800 m/min or even more than 1100 m/min.

The quality of clamping is, inter alia, also dependent on how well potentially arising vibrations can be damped. A substantial source of such vibrations can be, for example, the rapid change of the number of milling cutting edges which are currently engaged in a subtractive manner with the workpiece. This can result, for example, in flexural vibrations which have a significantly impeding effect.

Other types of vibrations, which are however likewise damaging, can result from the tendency of a shank tool and in particular of an end milling cutter to tumble during operation. Tumbling is understood to mean the slight elastic deformation of the shank due to contact with the workpiece under the load of the advancing motion, which reoccurs with each revolution and varies in terms of location in the course of the revolution.

German Patent Application DE 10 2021 119 935 A1, corresponding to U.S. Publication No. 2023/0035681 A1, which is known from the prior art, takes these requirements into account in that the document provides a tool chuck for clamping tools which have a tool shank-having a sleeve section open at the free end thereof and made of preferably electrically conducting material which forms a tool receptacle for fixedly establishing the tool shank in a friction-fitting manner in the press fit by shrinkage, wherein the sleeve section—preferably in any case over the entire axial length of the tool receptacle—is formed of an inner sleeve and of an outer sleeve which in the operationally ready state receives the inner sleeve and is joined thereto without any clearance-preferably likewise made of an electrically conducting material.

### SUMMARY OF THE INVENTION

It is accordingly an object of the invention to provide a tool chuck, a method of using a tool chuck and a tool clamping system, which overcome the hereinafore-mentioned disadvantages of the heretofore-known devices, methods and systems of this general type, which further improve known chucks and which, in particular, can apply high clamping forces and at the same time can better handle arising vibrations.

With the foregoing and other objects in view there is provided, in accordance with the invention, a tool chuck for clamping tools having a tool shank, the tool chuck including a sleeve section which is open at the free end thereof, adjoins a tool chuck main body towards the free end, is made of preferably electrically conducting material and forms a tool receptacle for fixedly receiving the tool shank in a friction-fitting manner with an interference fit, in particular by shrinkage, wherein the sleeve section—preferably in any case over the entire axial length of the tool receptacle—is formed of an inner sleeve and an outer sleeve which in the operationally ready state receives the inner sleeve, is joined thereto without any clearance and preferably likewise is formed of an electrically conducting material, and an expansion gap between the tool chuck main body, the inner sleeve and the outer sleeve.

Advantageous refinements of the invention are the subject matter of dependent claims and of the description hereunder—and relate to the tool chucks, to the use as well as to the tool clamping system.

Unless explicitly defined otherwise-terms which may be used, such as top, bottom, front, rear, left or right, are to be understood according to their usual meaning—also in combination with the view of the present figures. If used and unless explicitly defined otherwise, terms, such as radial and axial, are to be understood in terms of central or symmetry axes of structural parts/components described here—also in combination with the view of the present figures.

The term “substantially”—if used—can be understood to mean (according to understanding of the supreme court) that “a practically still significant degree” is referred to thereby. Potential deviations from the exact specification thus implied by this terminology can thus be the unintentional result (i.e. without any functional reason) on account of manufacturing or assembling tolerances or the like.

The tool chuck—for clamping tools having a tool shank, such as, for example, milling tools or drilling tools—has a sleeve section which is open at its free end and adjoins a tool chuck main body towards the free end.

The sleeve section forms a tool receptacle for fixedly establishing the tool shank in a friction-fitting manner in the press fit, in particular by shrinkage. The sleeve section herein can preferably be made of electrically conducting material.

The sleeve section—preferably in any case over the entire axial length of the tool receptacle—is formed of an inner sleeve and an outer sleeve. The outer sleeve in the operationally ready state receives the inner sleeve and is joined to the latter without any clearance.

The outer sleeve can preferably also likewise formed of an electrically conducting material.

The tool chuck is which further comprises an expansion gap between the tool chuck main body, the inner sleeve and the outer sleeve.

An “expansion gap” here may be understood to mean a (narrow) void between two or more structural elements, presently between the tool chuck main body, the inner sleeve and the outer sleeve.

Such an expansion gap is preferably used wherever structural parts made of different materials and/or with different properties—e.g. susceptibilities to heat-related shrinkage and expansion—meet one another (joint).

While the term, “expansion gap,”-apart from its physical meaning as a gap—may also have a functional meaning, specifically in terms of tensions being dissipated—and cracks being prevented, the expansion gap presently provided in the tool chuck may—alternatively—also be referred to as, or considered to be, a relief groove.

A “relief groove” here may be a subtraction on a surface of a structural part, presently of the tool chuck main body, the inner sleeve and the outer sleeve, having a specific shape and established dimensions, which achieves a void (comparable to the expansion gap) at that location, this also imparting the term “relief groove” a meaning in terms of production technology. The void is in particular visible/formed when structural parts, i.e. presently the tool chuck main body, the inner sleeve and the outer sleeve, are joined to one another at that location.

In a simplified and visualized manner—the tool chuck is distinguished in that a void, specifically the expansion gap or the relief groove—more expediently and formed in a simple manner by subtraction of material, or “absent material”—on the tool chuck main body, the inner sleeve and the outer sleeve is provided at the joint between the tool chuck main body, the inner sleeve and the outer sleeve (in the case of an integral inner sleeve the void correspondingly being on the tool chuck main body—see below).

As a result of the expansion gap, or the relief groove, in the tool chuck, i.e. presently between the tool chuck main body, the inner sleeve and the outer sleeve, the tool chuck achieves that tensions are dissipated and cracks are prevented—at the joint between the tool chuck main body, the inner sleeve and the outer sleeve. In this way, in particular the service life of the tool chuck and/or the quality of the tool chuck—including all its properties, such as in particular its damping, —can be prolonged or improved, respectively.

In particular, it can be expedient when a groove, which achieves a, or the, void in the case of the expansion gap, or the relief groove, is formed in the tool chuck main body.

The tool chuck can furthermore also be which further comprises at least one first intermediate sleeve between the inner sleeve and the outer sleeve.

As a result of the at least one first intermediate sleeve between the inner sleeve and the outer sleeve, the tool chuck achieves a significant reduction of the tendency of the tool chuck towards damaging vibrations. In short, also the damping/vibration behavior of the tool chuck is improved.

It appears that the boundary layers at which the intermediate sleeve and the inner sleeve, or the outer sleeve, are in mutual contact in the region of the tool receptacle is responsible for this. Damping, or a reduced capability of transmitting vibrations, arises not least when metal impacts metal.

This appears to apply not least when the intermediate sleeve, the inner sleeve and the outer sleeve are in non-releasable mutual contact during normal operation, for example are press-fitted to one another, in particular because they are already press-fitted to one another prior to clamping a tool shank and the impeded expansion associated therewith, and their press-fit is yet again enhanced by the clamping of the tool shank.

This means that it can in particular also be expedient when the at least one first intermediate sleeve has an interference fit with the inner sleeve and/or the outer sleeve.

The tool chuck can furthermore also be characterized in that a functional face of at least one of the structural parts joined to one another at the sleeve section, in particular on an internal circumference or periphery of the outer sleeve or on an external circumference or periphery of the inner sleeve or on an internal circumference or periphery and/or external circumference or periphery of at least one or of the first intermediate sleeve disposed between the inner sleeve and the outer sleeve, is thermochemically heat-treated and/or coated.

Due to the coating, in particular however due to the thermochemical heat treatment, the tool chuck achieves that its functional faces are imparted a greater surface hardness so that the latter are provided with a greater resistance to abrasive, adhesive and corrosive wear.

It can be particularly expedient when the thermochemical heat treatment is nitriding with diffusion of nitrogen, such as plasma nitriding, vacuum nitriding or gas nitriding, for example, or is nitriding with diffusion of nitrogen and carbon, such as gas nitrocarburizing, plasma nitrocarburizing or salt bath nitrocarburizing, for example.

In this way, nitrogen may be diffused in a targeted manner into the peripheral zone of iron-based alloys or other alloys containing nitride formers during plasma nitriding and plasma nitrocarburizing in an ionized gas atmosphere. The plasma nitriding method, or the plasma nitrocarburizing method, is used in particular so that the functional faces are imparted a greater surface hardness so that the latter are provided with a greater resistance to abrasive, adhesive and corrosive wear.

Alternatively, it can also be provided that the tool chuck is also characterized in that hard materials or alloys are sprayed, or have been sprayed, on a functional face of at least one of the structural parts joined together at the sleeve section, in particular on an internal circumference of the outer sleeve or on an external circumference of the inner sleeve or on an internal circumference and/or external circumference of at least one or of the first intermediate sleeve disposed between the inner sleeve and the outer sleeve.

It can furthermore be provided that a second intermediate sleeve is disposed between the inner sleeve and the outer sleeve. In this case, it further also appears to be advantageous here that the second intermediate sleeve has a clearance fit with the inner sleeve and/or the outer sleeve.

It can also be provided that an intermediate sleeve, or one of the intermediate sleeves disposed between the inner sleeve and the outer sleeve, is formed of a material containing copper or of a shape memory material or of memory material or of a carbon fibre material or of a hard metal material or of a ceramic material and/or includes an Ampco material and/or has at least a hardness of 50 HRC, in particular in that the intermediate sleeve is harder than the outer sleeve.

Apart from the improvement in terms of the vibration or damping behavior also achieved as a result, this results in an improved sliding property—at a sufficient hardness, this preventing that the intermediate sleeve does not seize—on the functional faces.

It is also advantageous when a, or one of the, or the intermediate sleeve disposed between the inner sleeve and the outer sleeve, and/or the outer sleeve and/or the inner sleeve has at least one chamber which lies within the intermediate sleeve, or the outer sleeve, or the inner sleeve.

It can then also be provided here in terms of a refinement that damping members, in particular powder or oil, or rolling members, in particular balls, rollers or needles, in particular hard metal or ceramic rolling members, or (heavy metal or rubber) rings or (hard metal or rubber) inserts, optionally biased, in particular by a spring, which are ideally held in a cage (in particular a metal or plastics cage) are disposed in the at least one chamber.

As a result, the damping or vibration behavior of the tool chuck can be further improved.

Also, the external geometry of the intermediate sleeve can also have a void, for example as a result of a groove—having a corresponding advantageous effect in terms of damping/vibration. This also applies in an analogous manner to the inner sleeve or outer sleeve.

According to a further structural embodiment it is provided that the outer sleeve is welded or soldered to the tool chuck main body, ideally in that a flange of the outer sleeve is welded or soldered to a complementary mating flange or a complementary annular shoulder of the tool chuck main body, in particular by electron beam welding.

Specifically in the case of such welding or soldering, the expansion gap, or the relief groove, proves to be immensely advantageous; tensions arising due to heat are specifically dissipated here.

It can also be provided that (in a similar, or functionally similar, manner to the above chamber) at least one cavity, in which are disposed in particular damping members, in particular powder or oil, in particularly hydraulic oil, or rolling members, in particular balls, rollers or needles, in particular hard metal or ceramic rolling members, or (heavy metal or rubber) rings or (heavy metal or rubber) inserts, optionally biased, in particular by a spring, which are ideally held in a cage (in particular metal or plastics cage), is disposed between the inner sleeve and the outer sleeve and/or in the inner sleeve and/or in the outer sleeve.

As a result, too, the damping or vibration behavior of the tool chuck can be further improved.

Further, it also appears to be expedient when the at least one cavity is flushed using a liquid, in particular water, or gas-, as a result of which it is thus also possible to achieve a cooling effect/cooling function for the tool chuck. Such a coolant can be in particular water, CO₂, oil, air, MMS or the like.

In one structural embodiment, provision is also made for a chamber in the tool chuck main body, in which are disposed in particular members, in particular powder or oil, in particular hydraulic oil, or balls, rollers or needles, in particular hard metal or ceramic balls, or (heavy metal or rubber) rings or (hard metal or rubber) inserts, optionally biased, in particular by a spring, which are ideally held in a cage (in particular metal or plastics cage).

In particular, it also appears to be particularly expedient when the outer sleeve is connected to the inner sleeve, or the at least one first intermediate sleeve is connected to the inner sleeve and the outer sleeve by a press fit even when the tool chuck is at room temperature and does not have a tool shank clamped. This particular type of “preloading” in the sleeve section contributes in particular towards an improved clamping capability, as well as damping and vibration behavior.

It can also be provided that the outer sleeve is configured in such a way that, after the thermal expansion of the latter and the insertion of the tool shank to be clamped according to the intended use into the inner sleeve, the outer sleeve is impeded in terms of its shrinkage when cooling again, in particular due to one, or due to the, intermediate sleeve, and as a result substantially partially contributes towards generating the press fit in which the tool shank is held.

It can also be expedient when the inner sleeve is configured in such a way that the latter is under tension in the cold state, for example due to the “compressed” intermediate sleeve, and opens due to relaxation during the thermal expansion of the outer sleeve.

It proves particularly advantageous when the inner sleeve and the outer sleeve and the intermediate sleeve are formed of different material, for example of different steel grades, for instance in the form of a hardened, in particular insert-hardened and therefore preferably wear-unsusceptible steel for the inner sleeve and a hot-work steel for the outer sleeve.

Specifically in the case of such a material difference, the expansion gap, or the relief groove, proves to be immensely advantageous; tensions arising due to heat are specifically dissipated here.

In terms of production technology it can also be advantageous when the inner sleeve is a non-releasable, preferably integral constituent part of the tool chuck main body (integral connection—see above), which in particular also forms the coupling to the machine tool, preferably cylindrical or as a steep taper or polygon shank taper or KM4X or HSK coupling, optionally as regionally restricted variants MAS-BT (in Asia), ISO/DIN (in Europe) and CAT-V (in America).

According to one preferred refinement it is provided that the inner sleeve has a cylindrical or a conical external circumferential face, and the outer sleeve has a complementary, cylindrical or conical, internal circumferential face, or that the inner sleeve has a cylindrical or a conical external circumferential face, and the at least one first intermediate sleeve has a complementary, cylindrical or conical, internal circumferential face, or that the at least one first intermediate sleeve has a cylindrical or a conical external circumferential face, and the outer sleeve has a complementary, cylindrical or conical, internal circumferential face, and/or
that the inner sleeve and the outer sleeve, or the outer sleeve and the at least one first intermediate sleeve, or the inner sleeve and the at least one first intermediate sleeve, are joined to one another by compressing, wherein, in particular in a cylindrical embodiment of the circumferential faces of the sleeves, the internal circumferential face of the outer sleeve is diametrically undersized in relation to the external circumferential face of the inner sleeve, or in relation to the external circumferential face of the at least one first intermediate sleeve, or the internal circumferential face of the at least one first intermediate sleeve is diametrically undersized in relation to the external circumferential face of the inner sleeve.

It can also be provided that the sleeve section-preferably completely, substantially or largely in the region outside the axial extent of the tool receptacle—forms a centering region
in that the inner sleeve has an enlarged external diameter and the inner sleeve has a complementary internal diameter which, when mutually compressing the inner sleeve and the outer sleeve, in the axial direction forms a guide region in which the inner sleeve and the outer sleeve initially come into contact with one another and therein are guided on one another without any noticeable press fit, and in particular reach the press fit outside the guide region only in the course of being further pushed onto one another,
or
in that the inner sleeve has an enlarged external diameter and the, in particular second, intermediate sleeve has a complementary internal diameter which, when mutually compressing the inner sleeve and the, in particular second, intermediate sleeve, in the axial direction forms a guide region in which the inner sleeve and the, in particular second, intermediate sleeve initially come into contact with one another and therein are guided on one another without any noticeable press fit, and in particular reach a press fit outside the guide region only in the course of being further pushed onto one another,
or
in that the, in particular second, intermediate sleeve has an enlarged external diameter and the outer sleeve has a complementary internal diameter which, when mutually compressing the, in particular second, intermediate sleeve and the outer sleeve, in the axial direction forms a guide region in which the, in particular second, intermediate sleeve and the outer sleeve initially come into contact with one another and therein are guided on one another without any noticeable press fit, and in particular reach a press fit outside the guide region only in the course of being further pushed onto one another.

The guide region, or the centering region, by way of a preferably conical transition portion, can also herein transition into that portion of the sleeve section that is assigned to the tool receptacle, wherein no bearing action of functional faces of the sleeves on one another takes place in particular in the region of this preferably conical transition portion.

It can furthermore prove expedient when the outer sleeve-preferably downstream of its potential guide region in the push-fitting direction-forms a flange with through-holes, which is faced by a complementary flange or a complementary annular shoulder having female tapped bores or freely projecting stud bolts formed by the tool chuck main body, preferably in such a way that the outer sleeve can be pressed onto the inner sleeve by screwing to the tool chuck main body, wherein removing devices for pressing the outer sleeve off again, ideally by using thrust screws, are preferably provided.

This form of axial support contributes in particular towards significantly reducing the tendency of the tool chuck to damaging vibrations.

A coolant duct which, by way of its aperture, preferably opens out at the free frontal end of the sleeve section, so as to dispense coolant there to the tool, can also be provided, wherein the at least one coolant duct is preferably formed primarily by a circumferentially inherently closed bore through the outer sleeve and/or secondarily by a circumferentially inherently closed bore through the inner sleeve.

An also particularly preferable refinement provides a, or the, expansion gap between the tool chuck main body, the inner sleeve and the outer sleeve, and at least one, or the, first intermediate sleeve between the inner sleeve and the outer sleeve, and a, or the, second intermediate sleeve between the inner sleeve and the outer sleeve, wherein the first intermediate sleeve is disposed between the inner sleeve and the outer sleeve by an interference fit, and the first and the second intermediate sleeve are disposed so as to be axially spaced apart from one another in such a way that the first intermediate sleeve, in the direction towards the free open end, is disposed after the second intermediate sleeve. This refinement furthermore also provides a thermochemically heat-treated, in particular plasma-nitrided or gas-nitrided, functional face of at least one of the structural parts joined to one another for the sleeve section, in particular on an, or the, internal circumference of the outer sleeve or on an, or the, external circumference of the inner sleeve or on an, or the, internal circumference and/or external circumference of at least one intermediate sleeve.

All substantial aspects of the tool chuck with all its advantages—described above—then specifically come to bear here.

With the objects of the invention in view, there is furthermore provided a method of using the tool chuck for high-speed subtractive machining, in particular high-speed milling (HSC), both at a cutting rate of more than 800 m/min, preferably more than 1100 m/min, or high performance milling (HPC) or CAD/CAM-optimized trochoidal milling.

With the objects of the invention in view, there is concomitantly provided a tool clamping system including at least one tool chuck and a shank tool which is adapted thereto in terms of its nominal shank diameter.

It can finally be asserted in terms of the invention (in all its aspects presented here, such as expansion gap/relief groove, intermediate sleeve and thermochemical heat treatment/coating) that the invention in all its aspects is distinguished in particular by simplicity, efficiency and effectiveness.

The description previously provided of advantageous structural embodiments of the invention includes numerous features that are presented in some cases collectively in combination in the individual dependent claims. The features may however expediently also be considered individually and combined to form meaningful further combinations.

Even though some terms are used in each case in the singular or in conjunction with a numeral in the description and/or in the patent claims, it is not the intention for the scope of the invention to be restricted to the singular or the respective numeral for the terms. Furthermore, the words “a” or “an” are to be understood not as numerals but as indefinite articles.

The characteristics, features and advantages of the invention described above, and the manner in which these are achieved, will become clearer and more comprehensible in conjunction with the following description of the exemplary embodiments of the invention that will be explained in more detail in conjunction with the drawing(s)/figure(s) (identical structural parts/components and functions have the same reference signs in the drawings/figures).

The exemplary embodiments serve to explain the invention and do not restrict the invention to combinations of features indicated therein, not even with respect to functional features. In addition, features suitable for this purpose of any exemplary embodiment can also be considered explicitly in isolated form, can be removed from one exemplary embodiment, can be introduced into another exemplary embodiment to supplement the latter and can be combined with any of the claims.

Other features which are considered as characteristic for the invention are set forth in the appended claims.

Although the invention is illustrated and described herein as embodied in a tool chuck, a method of using a tool chuck and a tool clamping system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIGS. 1a, 1b and 1c are diagrammatic, sectional views of a tool chuck, for example a shrink-fit chuck, having an expansion gap and intermediate sleeves according to an embodiment according to the invention;

FIGS. 2a, 2b and 2c are sectional views of a tool chuck, for example a shrink-fit chuck, having intermediate sleeves that have chambers according to an embodiment according to the invention;

FIGS. 3a, 3b and 3c are sectional views of a tool chuck, for example a shrink-fit chuck, having balls according to an embodiment according to the invention;

FIGS. 4a, 4b and 4c are sectional views of a tool chuck, for example a shrink-fit chuck, having rollers according to an embodiment according to the invention;

FIGS. 5a and 5b are sectional views of a tool chuck, for example a shrink-fit chuck, having a damping chamber—that has a resiliently mounted damping element—in the tool chuck main body according to an embodiment according to the invention; and

FIGS. 6a and 6b are sectional views of a tool chuck, for example a shrink-fit chuck, having thermochemically heat-treated functional faces according to an embodiment according to the invention.

### DETAILED DESCRIPTION OF THE INVENTION

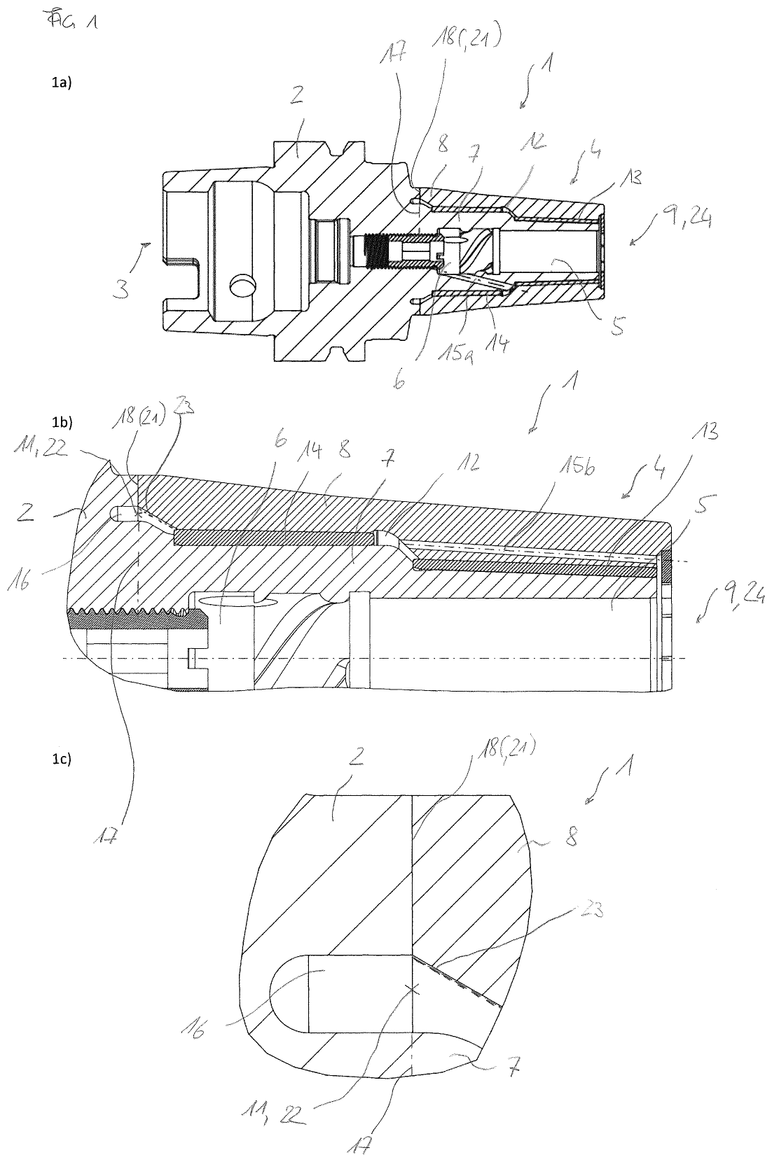

Referring now to FIGS. 1 to 6 of the drawings in detail, there are seen various tool chucks 1—in each case in different views and details.

Tool chuck 1 having an expansion gap 11 and intermediate sleeves 13, 14 (FIGS. 1a, b, c)

The tool chuck 1, presently as a shrink-fit chuck, has a tool chuck main body 2. The latter, on its rear end 3, has a coupling for coupling to a machine tool, which in FIG. 1 by way of example is an HSK coupling.

Alternatively, an SK coupling or any other system is likewise readily conceivable, however. The terms HSK and SK used for the couplings to be preferably used here are well known to persons skilled in the art, because the couplings are used as standard in many places.

The tool chuck 1, on its front, free end 9 that faces away from the coupling, forms a sleeve section 4.

Implemented within the sleeve section 4 is a tool receptacle 5 which firmly holds the shank of the tool, for example of an end milling cutter, (not shown).

The sleeve section 4—in the axial direction—behind, i.e. opposite the front, free end 9, the tool shank, a run-out region 6 which is not utilized by this tool shank, or not used for holding the latter. Coolant can be supplied into the sleeve section 4 by way of this run-out region 6.

This sleeve section 4 is configured in such a way and is used in such a way that it can hold a tool shank in the interference fit such that the latter neither rotates relative to the tool chuck 1 nor is extracted or slips in the axial direction, in any case in a substantial manner, while working with the tool.

The details of a shrink-fit process used in this context and of the corresponding tool chuck configuration as a shrink-fit chuck are described in German Patent Application DE 199 15 412 A1, corresponding to U.S. Pat. Nos. 6,712,367 B1 and 6,991,411 B2, or German Patent Application DE 10 2021 199 935 A1, both herewith being fully incorporated as the subject matter of this disclosure and the features thereof therefore being able to be referred to-optionally for limiting the claims that are the subject matter of the application.

The tool chuck 1 in terms of its sleeve section 4 differs from such a sleeve section from the application mentioned in that the sleeve section 4 is constructed in two layers (7, 8)—having intermediate members (13, 14) which are correspondingly disposed between the two layers (7, 8). In any case along the axial region in which the sleeve section forms the tool receptacle 5, —often even therebeyond across the region of the run-out 6, as can be seen in FIG. 1 here.

The sleeve section is constructed in two layers with an intermediate layer, in that the sleeve section is formed of an inner sleeve 7—which in this case is integrally connected to the tool chuck main body 2—(cf. the coupling point 17 of the inner sleeve 7 to the tool chuck main body 2, which is only imaginary here due to the integral configuration-marked in FIG. 1a) and of an outer sleeve 8 and two intermediate sleeves 13, 14 disposed—therebetween—axially lying behind one another.

An (annular) void, or transition portion 12, is formed between the two intermediate sleeves 13, 14, i.e. the front intermediate sleeve 13 and the rear intermediate sleeve 14, where a radial spacing remains between the outer sleeve 8 and the inner sleeve 7 even when both are completely assembled and ready for use (cf. further below in the context of the cooling ducts 15).

Whereas the inner sleeve 7 is integrally connected to the tool chuck main body 2, the outer sleeve 8 is welded (21) to the tool chuck main body 2—by electron beam welding—(at the corresponding coupling point 18 on the tool chuck main body 2—marked in FIG. 1a)—ideally (not shown) in that a flange of the outer sleeve 8 is welded to a complementary mating flange or a complementary annular shoulder of the tool chuck main body 2.

In turn, all structural parts preferably are formed of metal or steel, but preferably of different steel grades.

In one embodiment, the tool chuck main body 2 can also be formed of different materials. In this way, the rear end 3 can be formed of steel, for example, and the inner sleeve 7 which is constructed on the end 3 by way of an additive method, for example, can be formed of another material such as, e.g. aluminum.

Formed at the common joint 22 where the tool chuck main body 2, the inner sleeve 7 and the outer sleeve 8 meet one another ((only) in an imaginary sense, due to the integral construction), is an expansion gap 11, or relief groove 11 (cf. in particular FIG. 1c)—in that ideally material has been removed on the tool chuck main body 2, the inner sleeve 7 and the outer sleeve 8—and a not insignificant, noticeable void (i.e. the expansion gap/the relief groove 11) is thus formed between the structural parts 2, 7, 8 mentioned (at the joint 22 of the latter).

While the material removal in the case of the outer sleeve 8 can be performed on the inner surface of the latter (cf. marking 23 in FIGS. 1b, c), for example, the material removal in the case of the tool chuck main body 2 can be performed by way of a groove 16, as shown here.

Due to the expansion gap 11, or the relief groove 11, in the tool chuck 1, i.e. presently between the tool chuck main body 2, the inner sleeve 7 and the outer sleeve 8, the tool chuck 1 achieves that in particular thermally caused (cf. electron beam welding) tensions are dissipated and cracks are prevented—at the joint 22 of the tool chuck main body 2, the inner sleeve 7 and the outer sleeve 8.

The inner sleeve 7 and the outer sleeve 8 are connected to one another without any clearance—in such a manner—by way of the front intermediate sleeve 13 (i.e. lying towards the free end 9, or on the free end 9)—that at least the front intermediate sleeve 13 sits in interference fits between the inner sleeve 7 and the outer sleeve 8—whereas the rear intermediate sleeve 14 (i.e. lying towards the end 3 facing away from the free end 9, or lying opposite the free end) can sit in a clearance fit between at least one of the inner sleeve 7 and outer sleeve 8.

The respective—presently cylindrical—functional faces on the inner sleeve 7, the outer sleeve 8 and the rear intermediate sleeve 14 provide corresponding undersized dimensions; this rear intermediate sleeve 14 can thus then be easily pushed onto the inner sleeve 7—when joining the structural parts.

This clearance at this location typically also exists when the tool chuck 1 does not yet clamp a shank but waits at room temperature unused for its next job.

However, if the “clamping system” being formed of the inner sleeve 7, the outer sleeve 8 and the intervening front intermediate sleeve 13 is under tension—due to their respective interference fits (on their functional faces)—and are therefore in particular “closely in contact,” this generates high, vibration-damping friction.

These interference fits can be established in particular in that the inner sleeve 7, at least along the predominant axial length of the tool receptacle 5, has a conical external circumferential face. In this instance, the front intermediate sleeve 13 has a complementary, correspondingly conical internal circumferential face.

The front intermediate sleeve 13—again at least along the predominant axial length of the tool receptacle 5—then further provides a conical external circumferential face—and furthermore—the outer sleeve 8 has a complementary, correspondingly conical internal circumferential face.

In the case of all functional faces (that form the press fit), the cone angles would be the same, this however would not have to thus be mandatory. Different cone angles would also be able to be implemented, for example by way of a front intermediate sleeve 13 with different inner and outer cones (—the complementary functional faces on the inner sleeve 7 and the outer sleeve 8 would in this instance be corresponding to these cone angles).

If the front intermediate sleeve 13 is then pushed or pressed onto the inner sleeve 7 in the axial direction—and the outer sleeve 8 is then furthermore pushed or pressed onto the front intermediate sleeve 13, this then generates the desired press fit/press fits.

This can also take place by shrinking operations using the structural parts mentioned—without the conical functional faces being required in this case—and which in this case could be performed by corresponding oversized dimensions on the functional faces, which in this instance are then cylindrical, for example.

Furthermore, the tool chuck forms a (coolant) duct profile—through a first cooling duct 15a, which is formed in the inner sleeve, from the run-out region 6 in an intermediate space 12 between the inner sleeve 7 and the outer sleeve 8 and there between the rear intermediate sleeve 14 and the front intermediate sleeve 13, i.e. into the transition portion 12, and through a second cooling duct 15b, which is formed in the outer sleeve 8, from the intermediate space/transition portion 12 up to the front, free end 9 of the outer sleeve 8, through the use of which coolant can be directed up to the end side 24 of the tool chuck 1.

The two ducts 15a, 15b mentioned here are embodied substantially as longitudinal bores.

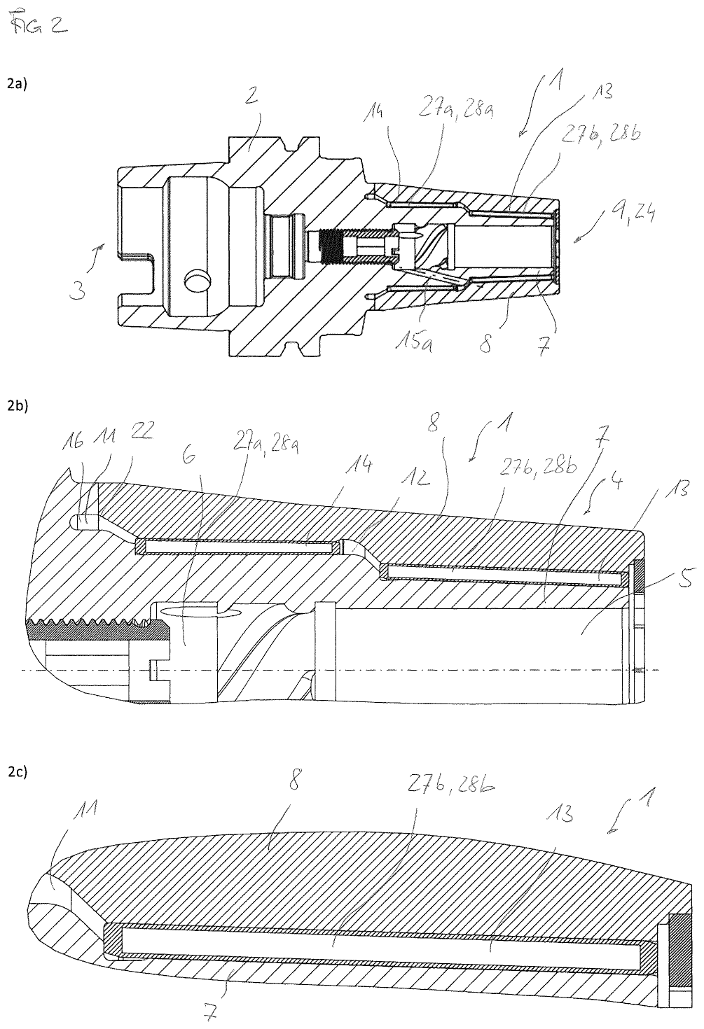

(The tool chucks 1 shown in FIGS. 2 to 6 are constructed/configured so as to correspond to the tool chuck 1 from FIG. 1—with the exception of further/other—likewise—advantageous details, which are then (only) to be described in more detail in the context of the respective FIG. 2, 3, 4, 5 or 6. Items which are illustrated but not mentioned in the context of FIGS. 2 to 6 can be obtained from (the description of) FIG. 1.

Tool Chuck 1 Having Intermediate Sleeves that have Chambers 27a, 27b (FIGS. 2a, 2b, 2c)

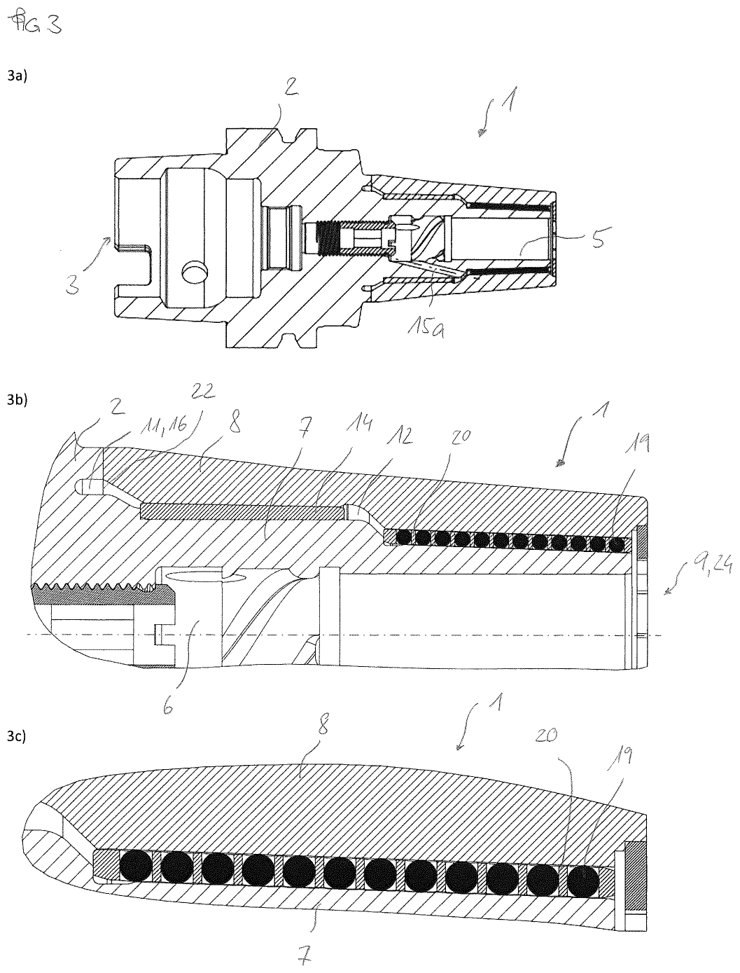

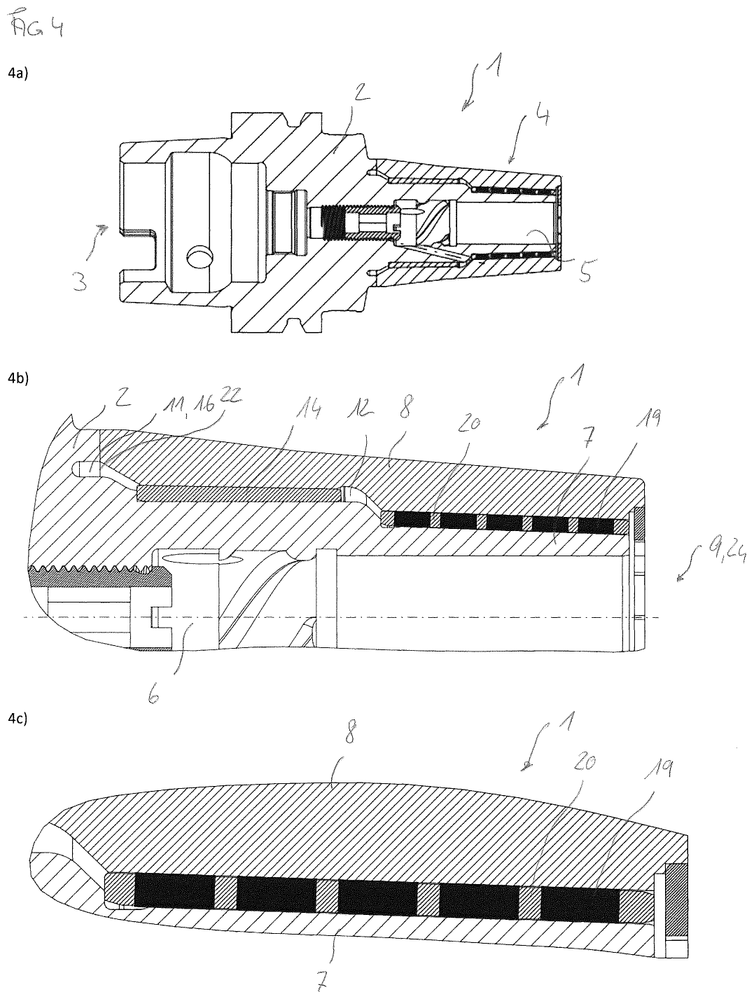

In this tool chuck 1, the front intermediate sleeve 13 and optionally also, as shown here, the rear intermediate sleeve 14 have in each case one internal (annular) chamber 27a, or 27b, respectively. The two (annular) chambers 27a, b in the intermediate sleeves 13, 14 are—in this case—not filled—and thus provide in each case one void, or cavity, 28a, b (cf. in this regard also FIGS. 3 and 4).

This void/cavity 28a, or 28 b, or such a “hollow, annular” chamber 27a, or 27b, contributes in particular towards an improved vibration and damping behaviour in the tool chuck 1.

### Tool Chuck 1 Having Balls 19 (FIGS. 3a, 3b, 3c)

The tool chuck 1 shown here provides that—instead of the above-mentioned front intermediate sleeve 13—balls 19 (“three-dimensional spherical member”) which are held/guided in a ball cage 20 are present at this location.

Here too, the balls 19 are under a press fit (by the outer sleeve 8 and the inner sleeve 7), so that the “clamping system” being formed of the inner sleeve 7, the outer sleeve 8 and—in this case—the intervening “spherical member” is also under tension here, is as a result in particular “closely in contact”—and this generates high, vibration-damping friction.

Whereas the balls 19 are presently disposed in the interference fit, this does not have to be the case with the cage 20. The latter can be disposed with a clearance between the inner sleeve 7 and the outer sleeve 8. Alternatively, an interference fit would also be possible in the case of the cage 20, however.

This spherical member, or these balls 19 (which are distributed in a hollow-cylindrical manner) likewise contributes, or contribute, towards an improved vibration and damping behavior in the tool chuck.

### Tool Chuck Having Rollers 19 (FIGS. 4a, 4b, 4c)

The tool chuck 1 shown here (similar to that from FIG. 3) provides that—instead of the above-mentioned front intermediate sleeve 13—(cylindrical) rollers 19 (“three-dimensional roller member”) which are held/guided in a roller cage 20 are present at this location.

Here too, the rollers 19 are under a press fit (by the inner sleeve 7 and the outer sleeve 8), so that the “clamping system” being formed of the inner sleeve 7, the outer sleeve 8 and—in this case—the intervening “roller member” is also under tension here, as a result is in particular “closely in contact”—and this generates high, vibration-damping friction.

Whereas the rollers 19 are presently disposed in the interference fit, this does not have to be the case with the cage 20. The latter can be disposed with a clearance between the inner sleeve 7 and the outer sleeve 8. Alternatively, an interference fit would also be possible in the case of the cage 20, however.

This roller member, or these rollers 19 (which are distributed in a hollow-cylindrical manner) likewise contributes, or contribute, towards an improved vibration and damping behavior in the tool chuck 1.

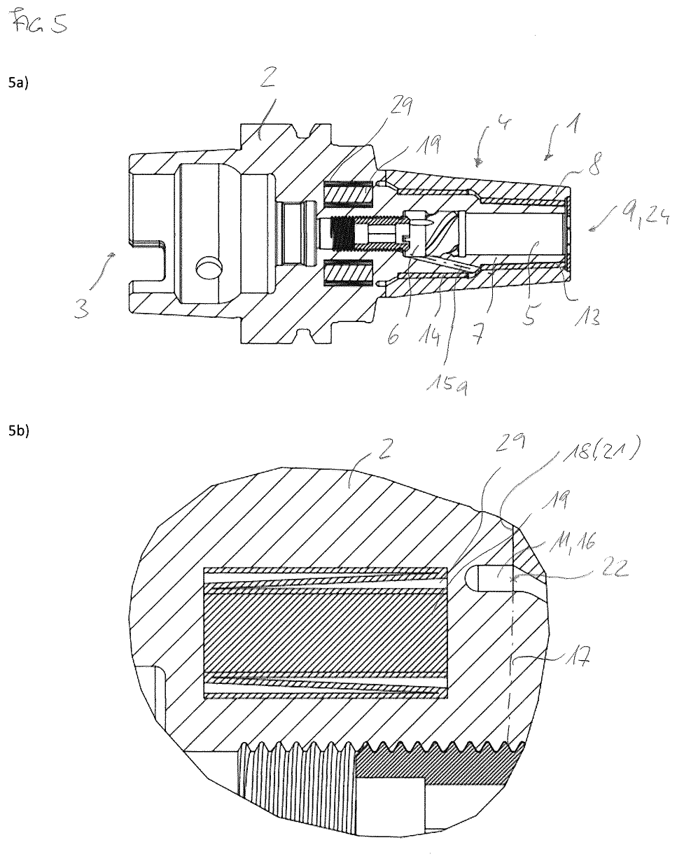

Tool Chuck 1 Having a Damping Chamber—that has a Resiliently Mounted Damping Element 19—In the Tool Chuck Main Body 2 (FIGS. 5a, 5b)

This tool chuck 1—disposed in the tool chuck main body 2—provides an annularly encircling chamber 29.

A damping member 19, in this case in the form of a hollow cylinder made of hard rubber, is resiliently mounted in this annular chamber 29.

This tool chuck, or this damping member, influences the vibration behaviour and thus the damping behavior of the tool chuck 1 in a particularly advantageous, because improved, way.

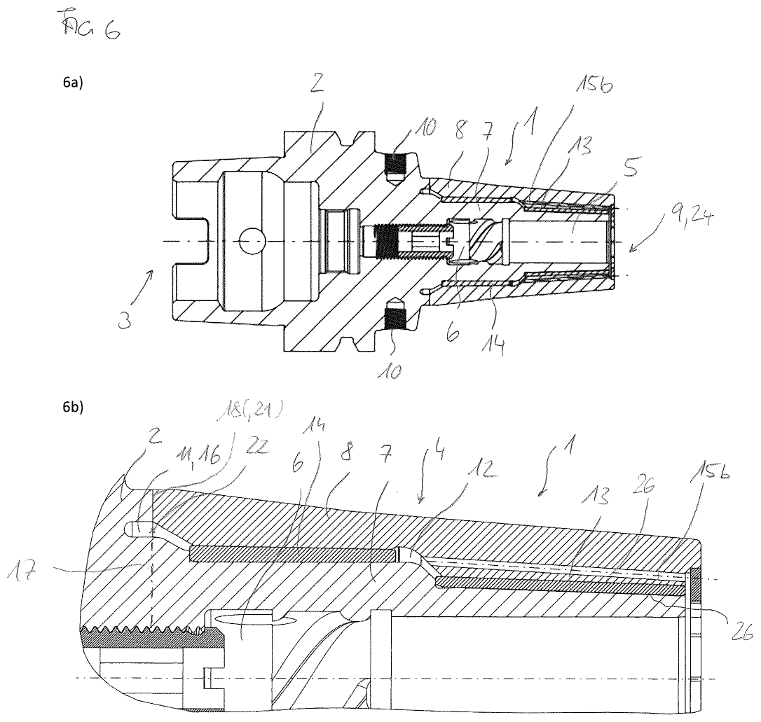

### Tool Chuck Having Thermochemically Heat-Treated Functional Faces 26 (FIGS. 6a, 6b)

In this tool chuck 1, functional faces 26 of the “clamping system”—being of the inner sleeve 7 (outer side), the outer sleeve 8 (inner side) and the front intermediate sleeve 13 (inner side and outer side) are thermochemically heat-treated—in this case treated by a plasma nitriding or plasma nitrocarburizing method, so as to impart the functional faces 26 a greater surface hardness, so that these are thus imparted a higher resistance to abrasive, adhesive and corrosive wear.

Moreover, functional faces 26 treated in this manner may also preferably act in a vibration-reducing manner.

Even when all functional faces 26 of the “clamping system” here—being formed of the inner sleeve 7 (outer side), the outer sleeve 8 (inner side) and the front intermediate sleeve 13 (inner side and outer side) are thermochemically heat-treated, only individual functional faces 26, for example the outer side and the inner side of the front intermediate sleeve 13 or the inner side of the outer sleeve 8 and the outer side of the inner sleeve 7, may also be (thermochemically) treated, as a result of which at least one functional face of a respective interference fit is thus in each case treated.

The tool chuck 1—presently on the outer side of the tool chuck main body 2—also provides different (balancing (tapped)) bores 10 which—when balancing—can optionally be filled with masses, presently balancing screws.

Even though the invention has been illustrated and described in further detail by the preferred exemplary embodiments, the invention is not limited by the disclosed examples and other variations can be derived therefrom without departing from the scope of protection of the invention.

All of the features shown in the figures may also be important to the invention—individually or in combination—or may be at least beneficial for the invention—and can therefore also be claimed individually or in combination (in claims).

The following is a summary list of reference numerals and the corresponding structure used in the above description of the invention:
1 Tool chuck
2 Tool chuck main body
3 Rear end
4 Sleeve section
5 Tool receptacle
6 Run-out region
7 Inner sleeve
8 Outer sleeve
9 Front, free end
10 (Balancing (tapped)) bores with balancing screws
11 Expansion gap, relief groove
12 Transition portion
13 Front intermediate sleeve
14 Rear intermediate sleeve
15a, b Coolant duct, coolant bore
16 Groove (in 2)
17 Coupling point
18 Weld, coupling point
19 Damping member, damping element, ball, roller
20 (Ball/roller) cage
21 Welded/soldered connection, electron beam weld
22 Joint
23 Marking for material subtraction (on 8)
24 End side
26 Thermochemically heat-treated region/functional face, coating
27a, b Chamber
28a, b Void/cavity in 27a, b
29 (Damping) chamber (in 2)

1. A tool chuck for clamping a tool having a tool shank, the tool chuck comprising:
a tool chuck main body;
a sleeve section having an open free end, said sleeve section adjoining said tool chuck main body, and said sleeve section forming a tool receptacle for fixedly receiving the tool shank in a friction-fitting manner by an interference fit or by shrinkage;
said sleeve section, over at least a part of an axial length of said tool receptacle, being formed of an inner sleeve and an outer sleeve, said outer sleeve receiving and being joined to said inner sleeve without clearance in an operationally ready state; and
said tool chuck main body, said inner sleeve and said outer sleeve defining an expansion gap therebetween.

2. The tool chuck according to claim 1, wherein said tool chuck main body has a trench or a groove formed therein forming a void for said expansion gap.

3. A tool chuck for clamping a tool having a tool shank, the tool chuck comprising:
a tool chuck main body;
a sleeve section having an open free end, said sleeve section adjoining said tool chuck main body, and said sleeve section forming a tool receptacle for fixedly receiving the tool shank in a friction-fitting manner by an interference fit or by shrinkage;
said sleeve section, over at least a part of an axial length of said tool receptacle, being formed of an inner sleeve and an outer sleeve, said outer sleeve receiving and being joined to said inner sleeve without clearance in an operationally ready state; and
at least one first intermediate sleeve disposed between said inner sleeve and said outer sleeve.

4. The tool chuck according to claim 3, wherein said at least one first intermediate sleeve has an interference fit with at least one of said inner sleeve or said outer sleeve.

5. The tool chuck according to claim 3, which further comprises a second intermediate sleeve disposed between said inner sleeve and said outer sleeve.

6. The tool chuck according to claim 5, wherein said second intermediate sleeve has a clearance fit with at least one of said inner sleeve or said outer sleeve.

7. The tool chuck according to claim 3, wherein said at least one first intermediate sleeve or said second intermediate sleeve is at least one of:
formed of a material containing copper or of a shape memory material or of memory material or of a carbon fiber material or of a hard metal material or of a ceramic material, or
at least one of includes an Ampco material or has at least a hardness of 50 HRC, or
is harder than said outer sleeve.

8. The tool chuck according to claim 5, wherein at least one of said at least one first intermediate sleeve, said second intermediate sleeve, said outer sleeve or said inner sleeve has at least one chamber disposed therein.

9. The tool chuck according to claim 8, which further comprises damping members formed of powder or oil or rolling members or balls or rollers or needles formed of hard metal or ceramic or heavy metal or rubber rings or hard metal or rubber inserts being unbiased or biased or spring-biased or held in a cage formed of metal or plastic, are disposed in said at least one chamber.

10. A tool chuck for clamping a tool having a tool shank, the tool chuck comprising:
a tool chuck main body;
a sleeve section having an open free end, said sleeve section adjoining said tool chuck main body, and said sleeve section forming a tool receptacle for fixedly receiving the tool shank in a friction-fitting manner by an interference fit or by shrinkage;
said sleeve section, over at least a part of an axial length of said tool receptacle, being formed of an inner sleeve and an outer sleeve, said outer sleeve receiving and being joined to said inner sleeve without clearance in an operationally ready state;
said outer sleeve having an internal circumference and said inner sleeve having an external circumference;
at least one first intermediate sleeve disposed between said inner sleeve and said outer sleeve, said at least one first intermediate sleeve having an inner circumference and an outer circumference;
at least one of said internal circumference or external circumference of at least one of said sleeves having a functional face; and
said functional face being at least one of thermochemically heat-treated or coated, or having hard materials or alloys sprayed thereon.

11. The tool chuck according to claim 10, wherein said thermochemical heat treatment is nitriding with diffusion of nitrogen or plasma nitriding, vacuum nitriding or gas nitriding, or nitriding with diffusion of nitrogen and carbon or gas nitrocarburizing, plasma nitrocarburizing or salt bath nitrocarburizing.

12. The tool chuck according to claim 10, wherein said outer sleeve is welded or soldered to said tool chuck main body by welding or soldering or electron beam welding a flange of said outer sleeve to a complementary mating flange or a complementary annular shoulder of said tool chuck main body.

13. The tool chuck according to claim 10, wherein said inner sleeve and said outer sleeve define at least one cavity disposed therebetween or disposed in at least one of said inner sleeve or said outer sleeve, said at least one cavity receiving damping members or powder or oil or hydraulic oil or rolling members or balls or needles or hard metal or ceramic rolling members or heavy metal or rubber rings or hard metal or rubber inserts being unbiased or biased or spring-biased, and being held in a cage formed of metal or plastic.

14. The tool chuck according to claim 13, wherein said at least one cavity is purged by a liquid, water or gas.

15. The tool chuck according to claim 10, which further comprises a chamber disposed in said tool chuck main body, said chamber receiving members or powder or oil or hydraulic oil or balls or hard metal or ceramic balls or heavy metal or rubber rings or hard metal or rubber inserts being unbiased or biased or spring-biased, and being held in a cage formed of metal or plastic.

16. The tool chuck according to claim 10, wherein said outer sleeve is connected to said inner sleeve, or said at least one first intermediate sleeve is connected to said inner sleeve and said outer sleeve, by an interference fit when the tool chuck is at room temperature and does not hold or clamp a tool shank.

17. The tool chuck according to claim 10, wherein said outer sleeve is configured in such a way that, after a thermal expansion of said outer sleeve and an insertion of the tool shank to be clamped according to an intended use into said inner sleeve, said outer sleeve is impeded in terms of its shrinkage when cooling again, and as a result contributes partially towards generating the interference fit in which the tool shank is held.

18. The tool chuck according to claim 10, wherein said inner sleeve is configured to be under tension in a cold state and open due to relaxation during a thermal expansion of said outer sleeve.

19. The tool chuck according to claim 10, wherein at least one of said inner sleeve or said outer sleeve or said first intermediate sleeve is formed of different material or different steel grades or of a hardened or insert-hardened and wear-unsusceptible steel for said inner sleeve and a hot-work steel for said outer sleeve.

20. The tool chuck according to claim 10, wherein said inner sleeve is a non-releasable, integral constituent part of said tool chuck main body and forms a coupling to a machine tool or a cylindrical or steep tapered or polygonal shank taper or KM4X or HSK coupling or as regionally restricted variants MAS-BT, ISO/DIN and CAT-V.

21. The tool chuck according to claim 10, wherein at least one of:
said inner sleeve has a cylindrical or a conical external circumferential face and said outer sleeve has a complementary, cylindrical or conical, internal circumferential face, or said inner sleeve has a cylindrical or a conical external circumferential face and said at least one first intermediate sleeve has a complementary, cylindrical or conical, internal circumferential face, or said at least one first intermediate sleeve has a cylindrical or a conical external circumferential face and said outer sleeve has a complementary, cylindrical or conical, internal circumferential face,
or
said inner sleeve and said outer sleeve, or said outer sleeve and said at least one first intermediate sleeve, or said inner sleeve and said at least one first intermediate sleeve, are joined to one another by compressing cylindrical circumferential faces of said sleeves, said internal circumferential face of said outer sleeve is diametrically undersized relative to said external circumferential face of said inner sleeve, or relative to said external circumferential face of said at least one first intermediate sleeve, or said internal circumferential face of said at least one first intermediate sleeve is diametrically undersized relative to said external circumferential face of said inner sleeve.

22. The tool chuck according to claim 10, wherein:
said sleeve section, at least mostly in a region outside of an axial extent of said tool receptacle, forms a centering region, said inner sleeve has an enlarged external diameter and said outer sleeve has a complementary internal diameter, and upon mutually compressing said inner sleeve and said outer sleeve, in an axial direction forms a guide region in which said inner sleeve and said outer sleeve initially come into contact with one another and are guided therein on one another without any noticeable press fit, and reach a press fit outside said guide region only in a course of being further pushed onto one another,
or
said inner sleeve has an enlarged external diameter and a second intermediate sleeve has a complementary internal diameter which, upon mutually compressing said inner sleeve and said second intermediate sleeve in an axial direction, forms a guide region in which said inner sleeve and said second intermediate sleeve initially come into contact with one another and are guided therein on one another without any noticeable press fit, and reach a press fit outside said guide region only in a course of being further pushed onto one another,
or
said second intermediate sleeve has an enlarged external diameter and said outer sleeve has a complementary internal diameter which, upon mutually compressing said second intermediate sleeve and said outer sleeve in an axial direction, forms a guide region in which said second intermediate sleeve and said outer sleeve initially come into contact with one another and are guided therein on one another without any noticeable press fit, and reach a press fit outside said guide region only in a course of being further pushed onto one another.

23. The tool chuck according to claim 22, wherein said guide region or said centering region has a conical transition portion transitioning into a portion of said sleeve section associated with said tool receptacle, and no bearing action of functional faces of said sleeves on one another takes place in a region of said conical transition portion.

24. The tool chuck according to claim 10, wherein said outer sleeve, in front of a potential guide region thereof in a push-fitting direction, forms a flange with through-holes being faced by a complementary flange or a complementary annular shoulder having female tapped bores or freely projecting stud bolts formed by said tool chuck main body, permitting said outer sleeve to be pressed onto said inner sleeve by screwing to said tool chuck main body, and removing devices are configured for pressing said outer sleeve off again by thrust screws.

25. The tool chuck according to claim 10, which further comprises a coolant duct having an aperture opening out at a free frontal end of said sleeve section for dispensing coolant to a tool, said at least one coolant duct being formed at least one of primarily by a circumferentially inherently closed bore passing through said outer sleeve or secondarily by a circumferentially inherently closed bore passing through said inner sleeve.

26. The tool chuck according to claim 10, which further comprises:
a second intermediate sleeve disposed between said inner sleeve and said outer sleeve;
said tool chuck main body, said inner sleeve and said outer sleeve defining an expansion gap therebetween;
said first intermediate sleeve being disposed between said inner sleeve and said outer sleeve with an interference fit, and said first and second intermediate sleeves being axially spaced apart from one another in such a way that said first intermediate sleeve, in a direction towards said free open end, is disposed after said second intermediate sleeve; and
a thermochemically heat-treated or plasma-nitrided or gas-nitrided, functional face disposed at least one of on an internal circumference of said outer sleeve or on an external circumference of said inner sleeve or on at least one of an internal circumference or external circumference of at least one of said first intermediate sleeve or said second intermediate sleeve.

27. A method of using a tool chuck, the method comprising:
providing the tool chuck according to claim 1; and
using the tool chuck for high-speed subtractive machining.

28. The method according to claim 27, which further comprises carrying out the high-speed subtractive machining by high-speed milling or CAD/CAM-optimized trochoidal milling at a cutting speed of more than 800 m/min, or high performance milling.

29. The method according to claim 27, which further comprises carrying out the high-speed subtractive machining with the cutting speed being more than 1100 m/min.

30. A tool clamping system, comprising at least one tool chuck according to claim 1, and a shank tool having a nominal shank diameter adapted to the at least one tool chuck.
